(19) United States
(12) Patent Application Publication
(10) Pub. No.: US 2014/0041053 A1
(43) Pub. Date: Feb. 6, 2014

(54) DATA BLOCK ACCESS CONTROL

(71) Applicants: Aled Edwards, Charfield South Gloucestershire (GB); Alistair Coles, Bath Somerset (GB)

(72) Inventors: Aled Edwards, Charfield South Gloucestershire (GB); Alistair Coles, Bath Somerset (GB)

(21) Appl. No.: 13/562,696

(22) Filed: Jul. 31, 2012

(51) Int. Cl. G06F 21/00; G06F 17/30

(52) U.S. Cl. 726/28; 707/781; 707/E17.01

(57) ABSTRACT

In one implementation, a data block access system accesses access control information associated with a plurality of data blocks of a storage volume at a data store, and determines whether a user associated with a request for access to a data block from the plurality of data blocks is authorized for the requested access. The data block access system determines whether the user is authorized for the requested access based on the access control information associated with that data block.

### BACKGROUND

Access to data stored at a storage volume is typically managed at a per-volume level or at a file system level. As an example of per-volume access control, a storage volume such as a disk or solid-state drive within a storage appliance of a storage area network (SAN) can be mounted by a computing system after the computing system provides a credential associated with the storage volume. After the storage volume is mounted by the computing system, an operating system or driver of the computing system has access to all the data at the storage volume.

As an example of file system access control, typically, the data at the storage volume is organized within a file system. The operating system or driver of the computing system can interpret file system elements of the file system such as files and directories that include access control information (e.g., permissions or access control lists (ACLs)) to determine whether a particular process or task hosted at the computing system is authorized to access the data of the file system elements.

### BRIEF DESCRIPTION OF THE DRAWINGS

FIG. 1 is a flow chart of a process to access a data block at a storage volume, according to an implementation.

FIG. 2 is a flowchart of a process to determine access control information for data blocks at a storage volume based on a file system within the storage volume, according to an implementation.

FIG. 3 is an illustration of a storage volume, according to an implementation.

FIG. 4 illustrates an environment including a data block access system, according to an implementation.

FIG. 5 is a schematic block diagram of a block access system, according to an implementation.

FIG. 6 illustrates an environment including a data block access system, according to another implementation.

FIG. 7 is a schematic block diagram of a data block access system hosted at a computing system, according to an implementation.

### DETAILED DESCRIPTION

Although per-volume and file system access controls provide some security to storage volumes, such mechanisms fail to mitigate malicious or inadvertent access to data within a storage volume by an operating system. Typically, the integrity of an operating system accessing a storage volume as a block device is assumed to be trustworthy (e.g., not compromised) after successfully authenticating with a storage appliance or service, and the operating system is trusted to enforce file system access controls within the storage volume. However, this assumption can fail for some compromised operating systems. For example, an operating system compromised by malicious code such as a root kit can successfully authenticate with a storage appliance, and then erase or overwrite data at a storage volume that should not be altered. As another example, such an operating system (or the malicious code) can read sensitive data (e.g., cryptographic data or other data for which access should be limited) at the storage volume that should not be disclosed outside of, for example, a boot process.

As a specific example, a virtual machine that boots from a storage volume stored at a storage appliance within a SAN and executes a compromised operating system can spread malicious code to other virtual machines that boot from that storage volume by altering a portion of the storage volume storing bootstrap instructions and/or the operating system. Per-volume access controls do not prevent such access because the operating system has access to the entire storage volume after authenticating with the storage appliance. Similarly, file system access controls will not prevent such access because the operating system enforces such access controls.

Implementations discussed herein provide data block access control for storage volumes. Such implementations can limit access to particular data blocks (or groups of data blocks) of a storage volume to particular users (e.g., operating system instances, virtual machines, applications, processes, or entities within a computing system or environment) and to particular types of access (e.g., read, write, or delete). Data blocks are portions of a storage volume (or other block device) at which data can be stored at the storage volume. In some implementations, data block access controls can be implemented, for example, at a data block access system hosted by a storage appliance. Such implementations can prevent compromised operating systems or computing systems or virtual machines hosting such operating systems from accessing data at the storage volume in an unauthorized manner. Moreover, in some implementations, access control information for data blocks of a storage volume can be derived or inferred from a file system within (or of) the storage volume.

Such implementations can be useful, for example, to prevent access to data blocks within a storage volume that should not be accessed (e.g., read or modified) during normal or expected interaction of a user with the storage volume. Thus, access controls can be implemented for individual data blocks within a storage volume to provide finer granularity of access control than per-volume controls without reliance on user or client implementation of file system access controls.

For example, for some storage volumes, a boot portion, a cryptographic portion, and/or other sensitive portions should not be accessed during normal operation of a user of those storage volumes. Implementations discussed herein can allow users to access such storage volumes as block devices, without relying on the integrity of the user to enforce file system or other user-enforced (e.g., operating-system-enforced) access control. Preventing such unauthorized or unintended access can be particularly useful in distributed, utility, or cloud computing environments in which multiple users (e.g., virtual machines) can access a storage volume, and in which the number of users that may be exploited or compromised is large.

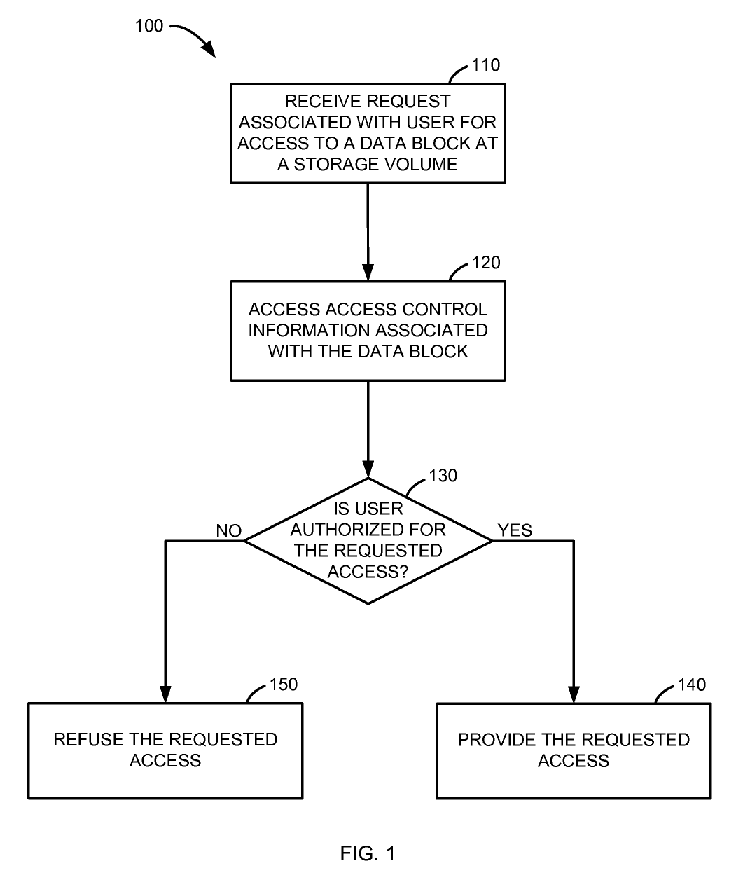

FIG. 1 is a flow chart of a process to access a data block at a storage volume, according to an implementation. Process 100 can be implemented at a data block access system such as a data block access system hosted by a storage appliance (e.g., a computing system providing access to storage volumes as data block devices). In some implementations, a storage appliance (or other computing system) hosting a data block access system can be referred to as a data block access system. Although process 100 and other processes are discussed in relation to a data block access system, such processes can be implemented in other environments.

A request for access to a data block at a storage volume is received at block 110. The request is associated with a user, relative to which authorization for the access will be determined or evaluated. The user can be identified by a unique identifier of the user or a session between the user and a data block access system implementing process 100. For example, the user can be an operating system (or a driver of an operating system), and can previously have authenticated with the data block access system. As part of the authentication process, the data block access system can provide the user with a session token to be included with requests for access to data blocks for a period of time during which the session token is valid. The data block access system can determine which user provided a request based on the session token included in the request by, for example, comparing the session token to a list of session tokens associated with different users.

As another example, the request can be associated with a particular user based on a communications channel via which the request is received. A communications channel can be a logical communications channel such as a TCP/IP (Transmission Control Protocol over Internet Protocol) socket or a physical communications port or interface that is associated with a user when the user is authenticated with the data block access system.

The request also identifies the data block using, for example, an identifier of the data block that is unique within the storage volume and the access that is requested. For example, the requested access can be read access, write access, delete access, or some other access. That is, for example, the request can indicate that the user is requesting to read data at the data block, write data to the data block, or delete data from the data block. Additionally, for write access to the data block, for example, the request can include data to be written to the data block. As an example of delete access for the data block, the request can indicate that the data block should be explicitly released or marked to indicate the data block is not being used by a user (e.g., that the data block does not include data that should be interpreted as valid). Such requests can be particularly applicable to thin provisioning of a storage volume, storage appliance, or storage service.

Access control information associated with the data block for which access is requested is then accessed at block 120. Access control information defines or describes the access for which users are authorized. For example, access control information can include a list of users (e.g., unique identifiers of users) and a description of the types of access (e.g., read, write, and/or delete) for which each user is authorized. As examples, a permissions list, an ACL, or user capabilities can be or include access control information.

Access control information associated with a data block is specific to a particular data block or subset of the data blocks of the storage volume. In other words, access control information associated with a data block does not apply to each other data block of the storage volume and is separate from access control information for the storage volume. Said differently, access control information that applies uniformly or invariably to each data block of a storage volume is not access control information associated with a data block. Accordingly, a data block access system implementing process 100 can impose, support, or enforce per-volume access control and data block access control. Said differently, a user can authenticate with the data block access system relative to or for access to a storage volume before block 110, and process 100 can be performed for each request for access to a data block or a group of data blocks at the storage volume. As a result, a data block access system can refuse or reject requested access before block 110 if the user associated with the requested access is not authorized to access the storage volume.

As a specific example of accessing access control information associated with the data block, the data block access system implementing process 100 can access a data store such as a table at a memory or a database accessible to a storage appliance or service that includes access control information for the data blocks of the storage volume. The data block access system can access the access control information for the data block for which access is requested, for example, using an identifier of the data block included in the request received at block 110. In some implementations, the access control information associated with the data block can be referred to as metadata for the storage volume or of data blocks of the storage volume.

In some implementations, the access control information for the data block is not indexed or stored relative to the data block. Rather, the access control information can be a capability of the user. Thus, access control information for the data block can be stored within a data store for each user of the storage volume. Accordingly, the data block access system can access access control information for the data block by accessing the capabilities of the user associated with the request.

Using the access control information associated with the data block, the data block access system implementing process 100 determines whether the user is authorized for the requested access at block 130. For example, the types of access for which the user is authorized can be described or defined within the access control information for the data block based on an identifier of the user. The requested access can be compared with the access for which the user is authorized to determine whether the user is authorized for the requested access.

If the user is authorized for the requested access (e.g., the type of access), the requested access is provided to the user at block 140. As examples: data stored at the data block can be provided to the user if the requested access is read access; data stored at the data block can be deleted if the requested access is delete access; or data stored at the data block can be modified or overwritten with data provided in the request if the requested access is write access. Said differently, the requested access can be provided to the user by performing an action or operation on or with data at the data block.

If the user is not authorized for the requested access, the requested access is refused (or not provided) at block 150. The requested access can be refused using a variety of methodologies. For example, the requested access can be refused by providing a notification to the user indicating the user is not authorized for the requested access. As another example, the requested access can be refused by providing a notification to the user indicating that the data block does not exist or could not be found. As yet another example, the requested access can be refused by providing a notification to the user indicating that the access to the data block failed. As a further example, the requested access can be refused by not providing any notification or response to the user. That is, the request for access can be ignored.

In some implementations, the requested access can be refused by not performing an action or operation on or with data at the data block and providing a notification to the user indicating that the requested access was successful. Such implementations can be useful to avoid modifications to users of a data block access system that assume that (or were programmed to operate as though) only per-volume access control are implemented for a storage volume.

As a specific example, in response to a request for write access for which the user is not authorized, a data block access system can not modify data at the data block, and can provide a write success notification to the user. Similarly, in response to a request for delete access for which the user is not authorized, a data block access system can not delete data at the data block, and can provide a delete success notification to the user. As another specific example, in response to a request for read access for which the user is not authorized, a data block access system can provide a read success notification including substitute data to the user. Substitute data is data that is provided in response to a request for data at a data block, but is not accessed at (e.g., read from) that data block. For example, substitute data can be random or pseudorandom data generated at a data block access system. As another example, substitute data can be a predetermined data set or pattern or data such as zero data or data with alternating bit values of 1 and 0.

Process 100 illustrated in FIG. 1 is an example of a data block access process. Other implementations can include additional and/or rearranged blocks or steps. As an example, in some implementations, process 100 can include a block at which access control information for the data block is modified or added.

More specifically, for example, if no data has been previously stored at a data block, access control information for that data block can be undefined, empty, free, or available. That is, the access control information for that data block can indicate that no authorization is specified or provided for that data block or that authorization is granted to all users for that data block. At block 130, the data block access system implementing process 100 can determine that the user is authorized for write access to such a data block, and provide the requested access (e.g., can store at the data block data provided with a request for write access to the data block) at block 140. Additionally, after or before block 140, the data block access system can modify the access control information for the data block based on or in response to the access requested by the user.

For example, the access control information for the data block can be modified to limit any access to the data block to the user or a group of users including the user, or to allow some access to the user and some other access to other users based on the request or a policy of a data block access system. As another example, the request can specify what access is authorized for the data block. As an example, the request can specify that the user have full access (e.g., read, write, and delete access) and other users (all other users or some group of other users) have limited access (e.g., read access only). As yet another example, if access control information associated with the data block is undefined (e.g., indicates the data block is not controlled), access control information for the data block can be set to indicate that only read access is allowed after a write operation to the data block.

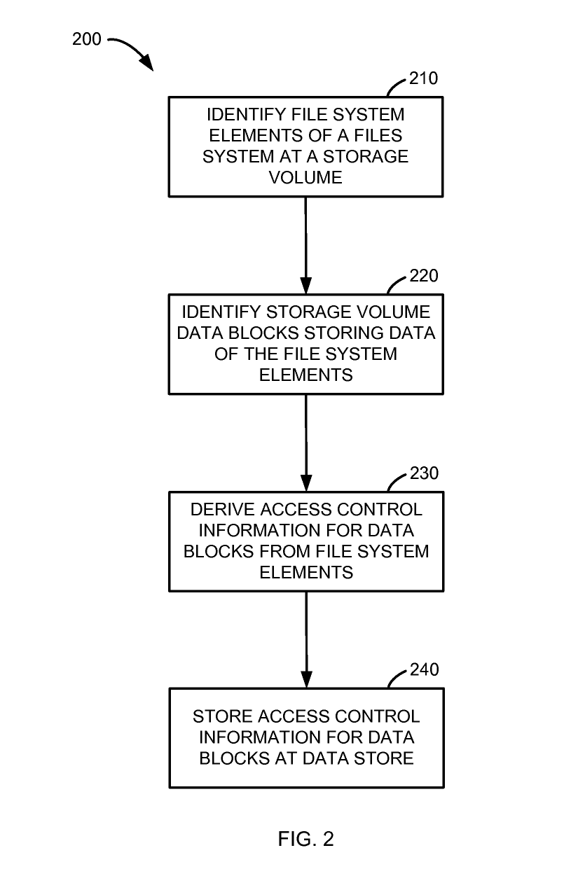

FIG. 2 is a flowchart of a process to determine access control information for data blocks at a storage volume based on a file system within (or at) the storage volume, according to an implementation. Process 200 can be implemented, for example, at a data block access system. For example, a data block access system can execute process 200 in response to addition of a storage volume to the data block access system to define access control information for the data blocks of the storage volume. As another example, a data block access system can execute process 200 periodically to synchronize access control information for the data blocks of a storage volume with access control information for file system elements of a file system within the storage volume.

A file system is a scheme of organizing data within a storage volume. A file system includes a group of file system elements within which the data within the storage volume are organized. For example, directories and files (or representations thereof) are file system elements of a file system. Typically, file system elements within a file system have associated access control information. For example, access control information can be defined as or within permissions, ACLs, or capabilities of users for file system elements. Such access control information defines which users are authorized for what access to the file system elements.

File system elements of a file system within a storage volume are identified at block 210. For example, a data block access system can walk or traverse a directory structure of a file system within a storage volume to identify directories and files of a file system. The data blocks of the storage volume at which each file system element is stored are then identified at block 220.

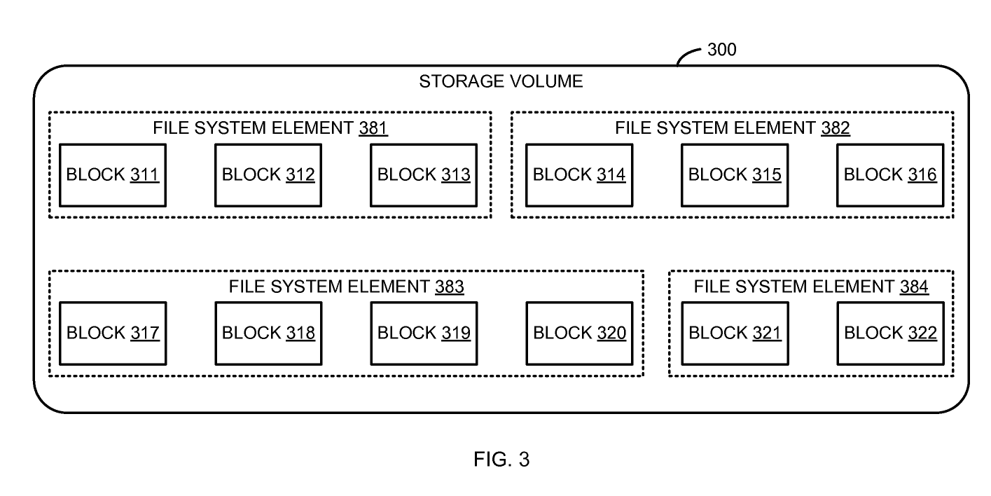

A storage volume typically is organized as a group or array of data blocks. For example, a storage volume can be organized as a consecutive group of fixed- or variable-length portions at which data can be stored. Such portions are referred to as data blocks. For example, FIG. 3 is an illustration of a storage volume, according to an implementation. Storage volume 300 can be a physical drive such as, for example, a hard disk drive (HDD), a solid state drive (SSD), or a FLASH memory drive; or a logical drive such as a partition of a physical drive, an image (e.g., bit-by-bit copy) of a physical drive, a RAM (random-access memory) disk, or some other logical or virtualized drive. Storage volume 300 includes data blocks 311-322. A file system including file system elements 381-384 is stored at storage volume 300. In other words, as an example, an operating system or driver of an operating system organizes data at the storage volume as file system elements according to a scheme defined by a file system.

However, data is stored and accessed at storage volume 300 within data blocks 311-322. That is, the file system is an abstraction of data blocks 311-322. The operating system or driver does not access data at storage volume 300 by reference to file system elements 381-384. Rather, the operating system or driver interprets the structure of the file system (e.g., based on descriptive information or metadata included within the file system) and accesses the data blocks storing file system elements (or storing the data of file system elements) at storage volume 300. In other words, storage volume 300 or a storage appliance or service hosting or providing access to storage volume 300 does not interpret the file system within storage volume 300 in response for requests to access data blocks 311-322. Rather, storage volume 300 or a storage appliance or service hosting or providing access to storage volume 300 receives requests for data blocks, and provides the requested access to the data blocks as discussed herein.

More specifically, in the example illustrated in FIG. 3, file system element 381 is stored at data blocks 311, 312, and 313. For example, file system element 381 can be a file, and the data stored at that file (i.e., file system element 381) is stored at data blocks 311, 312, and 313. Similarly, file system element 382 is stored at data blocks 314, 315, and 316; file system element 383 is stored at data blocks 317, 318, 319, and 320; and file system element 384 is stored at data blocks 321 and 322. Although the data blocks at which each of file system elements 381-384 are stored are numbered sequentially in FIG. 3, these data blocks are not necessarily sequential at storage volume 300.

Referring again to FIG. 2, the data blocks of the storage volume at which each file system element is stored can be identified at block 220 by, for example, walking or traversing the blocks of the storage volume based on the structure of the file system within the storage volume. For example, a directory file system element can include a list of other file system elements (e.g., files and other directories) accessible in the file system from that directory. An identifier of the first data block of the storage volume at which those other elements are stored can be included within the directory file system element. Thus, a data block access system implementing process 200 can iteratively identify the first data block of each file system element in a file system within the storage volume by traversing the file system (or file system structure) starting with a root file system element (e.g., a root directory).

In some file systems, each block at which a file system element is stored includes a reference to (e.g., an identifier of) the next data block at a storage volume storing data at that file system element. That is, the data blocks are joined together as a linked list, with the last data block at which data of the file system element is stored including an indication that no more data blocks are used to store the file system element. Referring to FIG. 3 as an example, file system element 384 can be a directory from which file system elements 381, 382, and 383 are accessible within the file system; and can include an identifier of data block 311 for file system element 381, an identifier of data block 314 for file system element 382, and an identifier of data block 317 for file system element 383. As discussed above, file system element 383 is stored at data blocks 317-320. Accordingly, data block 317 can include an identifier of data block 318, data block 318 can include an identifier of data block 319, data block 319 can include an identifier of data block 320, and data block 320 can include a indication (e.g., a NULL value) to indicate that data of file system element 383 is not stored at any more data blocks. In addition to these identifiers, each of data blocks 317-320 also includes data of file system element 383.

In other implementations, a directory file system element or one or more data blocks at which a file system element is stored includes a list of each data block at which that file system element is stored. In other words, in some implementations, the data blocks at which a file system element is stored are not organized as a linked list. Rather, a list of the identifiers of data blocks at which the file system element is stored is included at one or more data blocks. Thus, the data blocks at which a file system element is stored can be identified based on such lists. Referring to FIG. 2, the data blocks of the storage volume at which each file system element is stored can be identified at block 220 by traversing the file system structure and the data blocks of the storage volume according to these or other methodologies.

After the data blocks storing each file system element are identified at block 220, access control information associated with those data blocks is derived from that file system element at block 230. For example, the access control information associated with a data block can be inferred, copied, or otherwise derived from access control information such as permissions, ACLs, or user capabilities associated with the file system element stored at that data block. Thus, a user of the file system can have the same or similar access to data blocks storing file system elements of the file system as to those file system elements.

In some implementations, the access control information associated with the data block can be directly copied from access control information associated with the file system element. In other implementations, the access control information associated with the data block can be mapped from access control information associated with the file system element. For example, one type of access authorized within the access control information associated with the file system element can be mapped to a related or different type of access authorized within the access control information associated with the data block.

In some implementations, the access control information associated with the data block can be derived from the type of the file system element stored at that data block. For example, access control information associated with the data block at which a directory file system element is stored can have read access authorized for all users to prevent errors within an operating system accessing the storage volume. In some implementations, access control information associated with data blocks at which no file system element is stored can indicate that authorization for such a data block is undefined or that all users have full access (e.g., read, write, and delete) to that data block. In some implementations, the access control information associated with the data block can be derived from ownership of the file system element stored at that data block. As an example, the access control information associated with a data block storing a file system element owned or managed by a root, administrator, or super user of the file system (or operating system interpreting the file system) can authorize only reading and no writing for any user to prevent unintended modification to the data of that file system element. Moreover, in some implementations, the access control information associated with a data block can be derived from the file system element (e.g., from access control information associated with, the type of, or ownership of the file system element) stored at that data block using a variety of these or other methodologies.

The access control information associated with the data blocks is then stored at a data store at block 240. For example, the access control information can be stored at a memory or database accessible to a data block access system. The access control information can then be accessed, for example, as discussed above in relation to FIG. 1 in response to a request for access to a data block. In other implementations, such access control information associated with data blocks can be received at a data block access system from a user such as a system administrator.

Process 200 illustrated in FIG. 2 is an example of a data block access process. Other implementations can include additional and/or rearranged blocks or steps. As an example, in some implementations, process 200 can be iterative for each file system element. That is, blocks 210, 220, 230, and 240 can be iteratively performed for each file system element, rather than for multiple file system elements, within a file system within a storage volume.

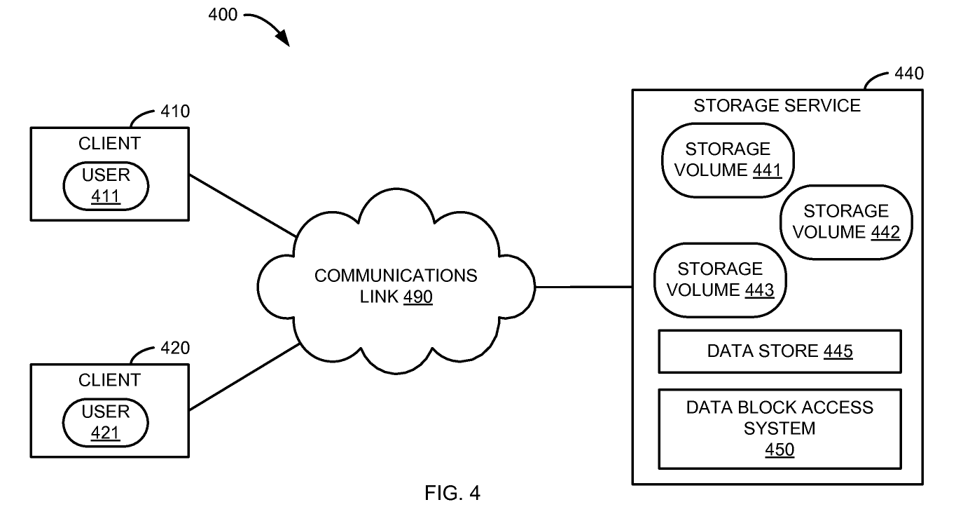

FIG. 4 illustrates an environment including a data block access system, according to an implementation. Environment 400 includes client 410, client 420, storage service 440, and communications link 490. Clients 410 and 420 are computing systems (e.g., desktop computers, notebook computers, tablet computers, smartphones, computer servers, or other computing systems) that access storage volumes at storage service 440, and include users 411 and 421, respectively, that are authorized for some access to one or more storage volumes accessible at storage service 440. As discussed above, users 411 and 421 can be each an operating system, a driver, an application, or a process under control of a person operating clients 410 or 420.

Communications link 490 includes devices, services, or combinations thereof that define communications paths between secured client 410, client 420, storage service 440, and/or other devices or services. For example, communications link 490 can include one or more of a cable (e.g., twisted-pair cable, coaxial cable, or fiber optic cable), a wireless link (e.g., radio-frequency link, optical link, or sonic link), or any other connectors or systems that transmit or support transmission of signals. Moreover, communications link 490 can include communications networks such as a switch fabric, an intranet, the Internet, other telecommunications networks, or a combination thereof. Additionally, communications link 490 can include proxies, routers, switches, gateways, bridges, load balancers, and similar communications devices.

Storage service 440 provides data block access to storage volumes 441, 442, and 443. In other words, storage service 440 provides access to storage volumes 441, 442, and 443 as data block devices rather than as a file systems or objects stores. As illustrated in FIG. 4, storage service 440 includes data block access system 450, and data store 445 to store access control information associated with data blocks of storage volumes 441, 442, and 443. As a specific example, storage service 440 can be hosted at a storage appliance within a SAN including communications link 490. As another specific example, storage service 440 can be cloud-based storage service and communications link 490 can include a portion of the Internet. In other words, storage service 440 can be accessible to clients 410 and 420 via the Internet. As discussed above, storage service 440 can be referred to as a data block access system because storage service 440 includes data block access system 450.

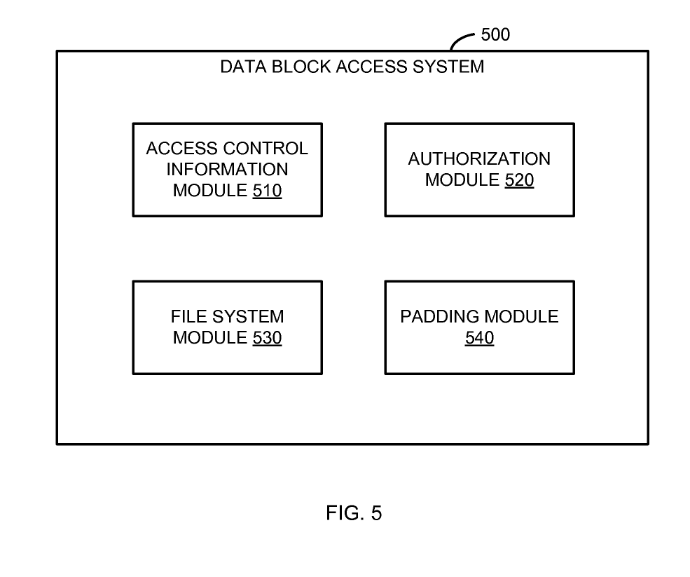

Data block access system 450 includes a combination of hardware and software to limit access to data blocks of storage volumes 441, 442, and 443 as authorized or defined in access control information associated with data blocks of storage volumes 441, 442, and 443 stored at data store 445. For example, data block access system 450 can include one or more modules to implement a data block access process such as process 100 discussed above in relation to FIG. 1 or other such processes. FIG. 5 is a schematic block diagram of a block access system, according to an implementation.

Data block access system 500 includes access control information module 510, authorization module 520, file system module 530, and padding module 540. Access control information module 510, authorization module 520, file system module 530, and padding module 540 can communicate one with another via, for example, a shared memory interface, a communications interface, a message passing interface, or some other interface or application programming interface (API).

Although these particular modules (i.e., combinations of hardware and software) and various other modules are illustrated and discussed in relation to FIG. 5 and other example implementations, other combinations or sub-combinations of modules can be included within other implementations. Said differently, although the modules illustrated in FIG. 5 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules. Moreover, in some implementations, modules of a data block access system can be distributed across multiple hosts such as computing devices.

Access control information module 510 accesses access control information associated with data blocks of a storage volume at a data store. For example, access control information module 510 can access access control information associated with data blocks derived from access control information for file system elements and stored at a database based on an identifier of the data block. As another example, access control information module 510 can access access control information associated with data blocks at file system module 530 after file system module 530 derives the access control information associated with data blocks from access control information for file system elements.

In some implementations, access control information module 510 modifies access control information associated with a data block in response to a request for access to the data block. For example, if access control information associated with a data block indicates that authorization for the data block is undefined or that all users have full access (e.g., read, write, and delete) to that data block, access control information module 510 can modify the access control information to authorize a user associated with a request such as a write request to have full access to that data block and other users to have read-only access or no access to the data block. In other words, access control information module 510 can update the access control information associated with the data block at the data store storing the access control information.

Authorization module 520 determines whether a user associated with a request for access to a data block is authorized for the requested access based on the access control information associated with the data block. For example, authorization module 520 can receive or access an identifier of the user associated with the requested access and access control information associated with the data block (e.g., from access control information module 510). Authorization module 520 can then determine based on, for example, symbols, codes, or instructions within the access control information associated with the data block whether the user is authorized for the requested access. Authorization module 520 can then output a signal or command to provide the requested access or to refuse the requested access.

File system module 530 derives access control information associated with data blocks at a storage volume from a file system within the storage volume. For example, as discussed above in relation to FIG. 2, file system module 530 can derive access control information associated with data blocks from access control information associated with file system elements stored at those data blocks. In other words, file system module 530 can implement process 200 or a similar process.

Padding module 540 generates substitute data if a user is not authorized for requested access to a data block. For example, as discussed above, substitute data generated by padding module 540 can be provided in response to a read access request for a data block for which a user associated with the read access request is not authorized. Padding module 540 can generate substitute data based on, for example, a random or pseudorandom number generator, a predetermined pattern, or one or more predetermined data sets.

In other implementations, data block access system 500 can include additional or fewer modules. For example, data block access system 500 can include a communications interface (or communications interface module) to receive requests for access to data blocks of a storage volume and to provide and/or refuse the requested access to data blocks. Moreover, data block access system 500 can include modules to authenticate users, to perform operations associated with requested access to data blocks (e.g., to provide requested access to data blocks), to implement communications protocols, and/or to perform other functions related to providing data block access to data blocks of storage volumes. In some implementations, such additional functions can be performed or implemented at a storage service or appliance hosting data block access system 500.

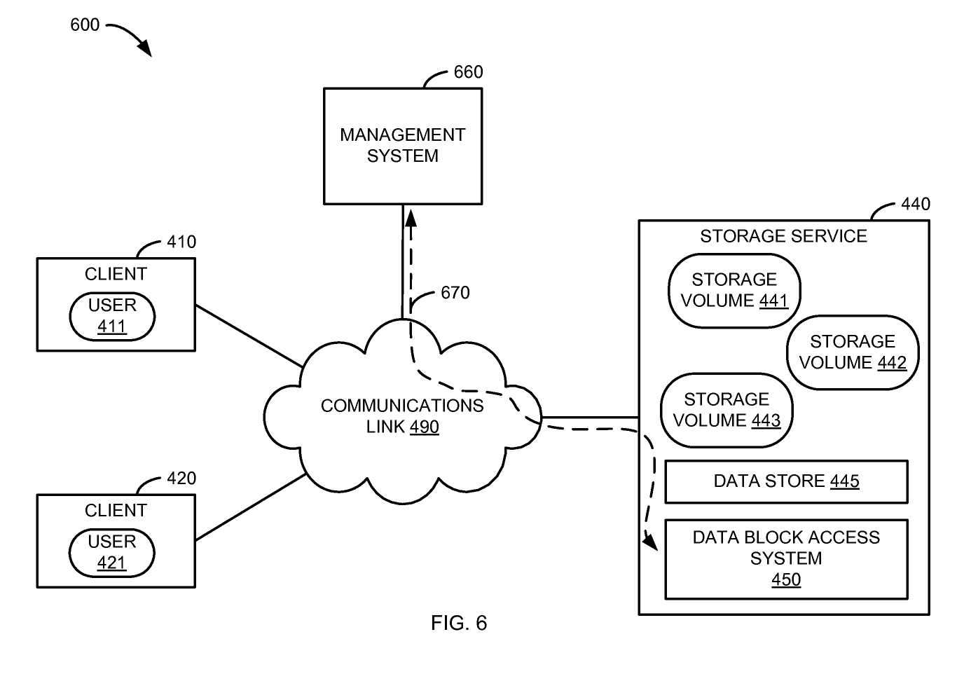

FIG. 6 illustrates an environment including a data block access system, according to another implementation. Environment 600 is similar to environment 400 discussed above in relation to FIG. 4. In addition to client 410, client 420, storage service 440, and communications link 490 (each discussed above in relation to FIG. 4), environment 600 includes management system 660. Management system 660 includes a combination of hardware and software that provides access control information associated with data blocks to data block access system 450. In some implementations, management system 660 also performs system management functions such as copying or moving storage volumes to storage service 440 from data stores.

As an example, an administrator of storage service 440, data block access system 450, or environment 600 can define or configure access control information for storage volumes 441, 442, and 443 via a user interface of management system 660, and that access control information can then be stored at data store 445. For example, management system 660 can provide that access control information via communications link 490 along communications path 670 to data block access system 450 or to data store 445 directly. As another example. Such a user can define a security policy that is applied to storage volumes 441, 442, and 443 or to data stored thereat to generate access control information, and that access control information can then be provided along communications path 670 to data block access system 450.

In some implementations, management system 660 derives access control information associated with data blocks of storage volumes 441, 442, and 443 from file systems within storage volumes 441, 442, and 443. For example, management system 660 can include a file system module such as file system module 530 discussed above in relation to FIG. 5 to define access control information associated with data blocks based on file system elements stored at those data blocks. As an example, management system 660 can access storage volumes 441, 442, and 443 at storage service 440 to derive access control information for data blocks of those storage volumes, and then provide that access control information to data block access system 450. As another example, management system 660 can receive a storage volume to be moved or copied to storage service 440, and can derive access control information for data blocks of that storage volume. After deriving the access control information for the data blocks, management system 660 can provide the access control information to data block access system 450 and that storage volume to storage service 440.

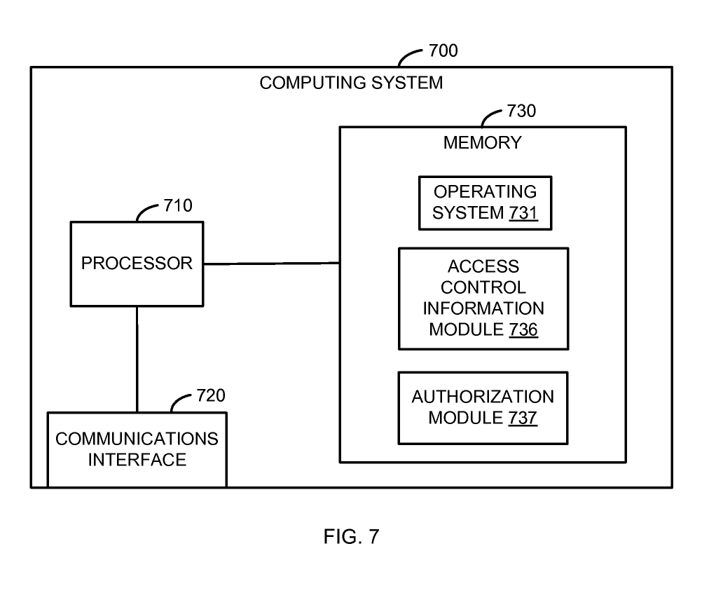

FIG. 7 is a schematic block diagram of a data block access system hosted at a computing system, according to an implementation. As discussed above in relation to storage appliances and services, a computing system hosting a data block access system can be referred to as a data block access system.

In the example illustrated in FIG. 7, computing system 700 includes processor 710, communications interface 720, and memory 730. Processor 710 is any combination of hardware and software that executes or interprets instructions, codes, or signals. For example, processor 710 can be a microprocessor, an application-specific integrated circuit (ASIC), a distributed processor such as a cluster or network of processors or computing systems, a multi-core or multi-processor processor, or a virtual or logical processor of a virtual machine.

Communications interface 720 is a module via which processor 710 can communicate with other processors or computing systems via communications link. As a specific example, communications interface 720 can include a network interface card and a communications protocol stack hosted at processor 710 (e.g., instructions or code stored at memory 730 and executed or interpreted at processor 710 to implement a network protocol) to receive and send data. As specific examples, communications interface 720 can be a wired interface, a wireless interface, an Ethernet interface, a Fiber Channel interface, an InfiniBand interface, and IEEE 802.11 interface, or some other communications interface via which processor 710 can exchange signals or symbols representing data to communicate with other processors or computing systems.

Memory 730 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 730 can be a volatile random access memory (RAM), a persistent data store such as a hard disk drive or a solid-state drive, a compact disc (CD), a digital video disc (DVD), a Secure Digital™ (SD) card, a MultiMediaCard (MMC) card, a CompactFlash™ (CF) card, or a combination thereof or other memories. Said differently, memory 730 can represent multiple processor-readable media. In some implementations, memory 730 can be integrated with processor 710, separate from processor 710, or external to computing system 700.

Memory 730 includes instructions or codes that when executed at processor 710 implement operating system 731, access control information module 736, and authorization module 737. Access control information module 736, and authorization module 737 can collectively be referred to as a data block access system. As discussed above, a data block access system can include additional or different modules (or components) than illustrated in FIG. 7.

In some implementations, computing system 700 can be a virtualized computing system. For example, computing system 700 can be hosted as a virtual machine at a computing server. Moreover, in some implementations, computing system 700 can be a virtualized computing appliance, and operating system 731 is a minimal or just-enough operating system to support (e.g., provide services such as a communications protocol stack and access to components of computing system 700 such as communications interface 720) access control information module 736, and authorization module 737.

The data block access system including access control information module 736, and authorization module 737 can be accessed or installed at computing system 700 from a variety of memories or processor-readable media. For example, computing system 700 can access a data block access system at a remote processor-readable medium via communications interface 720. As a specific example, computing system 710 can be a network-boot device that accesses operating system 731, access control information module 736, and authorization module 737 during a boot sequence.

As another example, computing system 700 can include (not illustrated in FIG. 7) a processor-readable medium access device (e.g., CD, DVD, SD, MMC, or a CF drive or reader), and can access control information module 736, and authorization module 737 at a processor-readable medium via that processor-readable medium access device. As a more specific example, the processor-readable medium access device can be a DVD drive at which a DVD including an installation package for one or both of access control information module 736, and authorization module 737 is accessible. The installation package can be executed or interpreted at processor 700 to install one or both of access control information module 736, and authorization module 737 at computing system 700 (e.g., at memory 730). Computing system 700 can then host or execute one or both of access control information module 736, and authorization module 737.

In some implementations, access control information module 736 and authorization module 737 can be accessed at or installed from multiple sources, locations, or resources. For example, one of access control information module 736 and authorization module 737 can be installed via a communications link (e.g., from a file server accessible via a communication link), and the other of access control information module 736 and authorization module 737 can be installed from a DVD.

In other implementations, access control information module 736 and authorization module 737 can be distributed across multiple computing systems. That is, some portions of access control information module 736 and authorization module 737 can be hosted at one computing system and other portions of access control information module 736 and authorization module 737 can be hosted at another computing system.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanism (e.g., sending data to a computing system or agent via a communications path or channel), pull mechanisms (e.g., delivering data to a computing system or agent in response to a request from the computing system or agent), and store mechanisms (e.g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

1. A non-transitory processor-readable medium storing code representing instructions that when executed at a processor cause the processor to:
receive a request for access to a data block at a storage volume, the request associated with a user of the storage volume;
identify a file system element of a file system within the storage volume;
determine access control information of the file system element, the data block storing data associated with the file system element; and
store the access control information associated with the data block based on the access control information of the file system element at a data store associated with the volume;
access the access control information associated with the data block;
determine whether the user is authorized for the access to the data block based on the access control information associated with the data block; and
provide the user with the access to the data block if the user is authorized for the access.

2. The processor-readable medium of claim 1, further comprising instructions that when executed at the processor cause the processor to:
identify a file system element of a file system within the storage volume;
read access control information of the file system element, the data block storing data associated with the file system element; and
define the access control information associated with the data block based on the access control information of the file system element.

3. The processor-readable medium of claim 1, further comprising instructions that when executed at the processor cause the processor to:
periodically synchronize the access control information for the data blocks with the access control information of the file system element.

4. The processor-readable medium of claim 1, further comprising instructions that when executed at the processor cause the processor to:
identify a file system element of a file system within the storage volume;
determine a type of the file system element, the data block storing data associated with the file system element; and
define the access control information associated with the data block based on the type of the file system element.

5. The processor-readable medium of claim 1, further comprising instructions that when executed at the processor cause the processor to:
provide a data block failure notification to the user if the user is not authorized for the access.

6. The processor-readable medium of claim 1, further comprising instructions that when executed at the processor cause the processor to:
provide substitute data to the user if the user is not authorized for the access.

7. The processor-readable medium of claim 1, further comprising instructions that when executed at the processor cause the processor to:
modify the access control information associated with the data block in response to the request.

8. A data block access system, comprising:
an access control information module to access access control information associated with a plurality of data blocks of a storage volume at a data store; and
an authorization module to determine whether a user associated with a request for access to a data block from the plurality of data blocks is authorized for the access based on the access control information associated with that data block,
in which the authorization module defines the access control information associated with the data block based on the type of access for which the user is authorized.

9. The system of claim 8, further comprising:
a file system module to derive the access control information associated with the plurality of data blocks from a file system within the storage volume.

10. The system of claim 8, further comprising:
a file system module to derive the access control information associated with the plurality of data blocks from access control information of a file system within the storage volume.

11. The system of claim 8, further comprising:
a file system module to determine the access control information associated with the plurality of data blocks based on file system elements of a file system within the storage volume.

12. The system of claim 8, further comprising:
a padding module to generate substitute data if the user is not authorized for the access.

13. The system of claim 8, further comprising:
a communications interface to receive the request and to provide the user with the access to the data block if the user is authorized for the access.

14. A data block access method, comprising:
with a processor:
identifying a plurality of file system elements within a file system within a storage volume;
identifying at the storage volume data blocks storing data of each file system element of the plurality of file system elements;
deriving access control information associated with each data block from the file system element whose data is stored at that data block; and
storing the access control information associated with each data block at a data store,
in which deriving access control information associated with each data block is based on a type of the file system element whose data is stored at that data block.

15. The method of claim 14, further comprising:
with the processor:
receiving a request for access to a data block from among the data blocks, the request associated with a user of the storage volume;
determining whether the user is authorized for the access to the data block based on the access control information associated with the data block; and
providing the user with the access to the data block if the user is authorized for the access.

16. The method of claim 14, further comprising:
with the processor:
receiving a request for access to a data block from among the data blocks, the request associated with a user of the storage volume;
determining whether the user is authorized for the access to the data block based on the access control information associated with the data block; and
providing substitute data to the user if the user is not authorized for the access.

17. The method of claim 14, wherein the deriving access control information associated with each data block is based on access control information associated with the file system element whose data is stored at that data block.

18. (canceled)

19. The method of claim 14, wherein the deriving access control information associated with each data block is further based on access control information associated with the file system element whose data is stored at that data block, ownership of the file system element, or on a combination thereof.

20. The method of claim 14, further comprising:
with the processor:
receiving a request for access to a data block from among the data blocks, the request associated with a user of the storage volume;
determining whether the user is authorized for the access to the data block based on the access control information associated with the data block;
providing the user with the access to the data block if the user is authorized for the access; and
modifying the access control information associated with the data block in response to the request.

21. The processor-readable medium of claim 1, in which the access control information associated with the data block that applies invariably to each data block of the storage volume is not access control information associated with the data block.

22. The system of claim 8, further comprising:
a storage service module to provide access to the storage volume as data block devices.
